(19) United States
(12) Patent Application Publication
(10) Pub. No.: US 2007/0026796 A1
(43) Pub. Date: Feb. 1, 2007

(54) Buried radio device

(75) Inventors: Shizuo Mizushina, Shizuoka-ken (JP); Atsushi Adachi, Shizuoka-ken (JP)

Correspondence Address: VENABLE LLP, P.O. BOX 34385, WASHINGTON, DC, 20043-9998, US

(73) Assignee: ENEGENE CO., LTD., Shizuoka-ken (JP)

(21) Appl. No.: 11/271,841

(22) Filed: Nov. 14, 2005

(30) Foreign Application Priority Data
Aug. 1, 2005 (JP) 2005-222675

(51) Int. Cl. H04B 13/02

(52) U.S. Cl. 455/40

(57) ABSTRACT

An underground space structure of a buried radio device includes an underground space, a metallic cover on the underground space, and an emission surface having a ring area including a structure material with transmission of electrical waves surrounding the cover. An underground radio device includes an underground antenna arranged apart from the cover in the underground and a radio device connected to the antenna. A radio device on the ground includes an antenna on the ground and a radio device connected to the antenna. The underground antenna and the antenna on the ground are connected via the emission surface including the ring area.

### BACKGROUND OF THE INVENTION

1. Field of the Invention

The present invention relates to a buried radio device arranged in the underground structure with a cover, including a radio device.

2. Description of the Related Art

With the above-mentioned underground structure, a manhole is well-known to be arranged for inspecting an underground buried pipe such as a water-supply and sewerage, a gas pipe, a communication line, or a power line. Many researches have been already done for communication between equipment in the underground and communication equipment on the ground, on the above-mentioned structure. The radio connections between the outside and the inside of the manhole are disclosed as the following methods.

(1) Use of a manhole iron cover as an antenna (U.S. Pat. No. 5,583,492)

(2) Production of an antenna by work of a manhole iron cover (U.S. Pat. No. 6,272,346)

(3) Radio communication through a hole opened on a manhole iron cover (Japanese Registered Utility Model No. 3061715)

According to the method (1), the manhole iron cover is not used for a frequency of several hundreds MHz or more because of the dimension (opening diameter: dimension for going-in and going-out of a person). According to the method (2), the mechanical work of the manhole cover becomes an obstacle against the wide use. According to the method (3), the radio waves are not effectively transmitted, other than a specific frequency.

In order to solve the above-mentioned problems, the inventor of the present invention performs the three-dimensional numerical simulation to predict the electromagnetic field generated by the buried radio device, and performs the experimental test to prove the simulation results. Results of the simulation and the experimental proving test indicate that the property of the radio emission depends on the following points.

1. Geometrical structure of a underground buried structuring member, such as a manhole

2. Structure, arrangement position, and direction of an antenna

3. Frequency (wavelength) of used radio waves

4. Dielectric properties of soil, concrete, and asphalt

### SUMMARY OF THE INVENTION

Accordingly, it is an object of the present invention to provide a buried radio device with means to overcome problems caused by the presence of the above-mentioned manhole iron cover.

It is another object of the present invention to provide a buried radio device with means to establish preferable communication to and from a counterpart radio device above the ground without changing the structure of existing underground equipment.

In order to achieve the above-mentioned objects, in a first aspect of the present invention, there is provided a buried radio device that is comprised an underground space structure comprising an underground space, a metallic cover on the underground space, and an emission surface having a ring area comprising a structure material with transmission of electrical waves surrounding the cover; an underground radio device comprising an underground antenna arranged apart from the cover in the underground and a radio device connected to the antenna; and a radio device on the ground comprising an antenna on the ground and the radio device connected to the antenna, wherein the underground antenna and the antenna on the ground are connected via the emission surface having the ring area.

In a second aspect of the present invention, there is provided a buried radio device according to the above first aspect, wherein a diameter of the cover is D and a wavelength of carrier of the radio device is λ, a rate (D/λ) of the diameter D to the used wavelength λ is approximately equal or more, and the angle of elevation of emitted electrical waves coming through the ground is determined depending on the rate and the position of the underground antenna to the cover.

In a third aspect of the present invention, there is provided a buried radio device according to the above second aspect, wherein the electrical waves coming through the ground form a distribution of equivalent wave-source spreading over the emission surface having the surface of ring area comprising the structure material surrounding the cover, and the distribution of the emitted electrical waves on the ground is prescribed by combined electrical waves emitted from the distributed equivalent wave-source.

In a fourth aspect of the present invention, there is provided a buried radio device according to the above first aspect, wherein a layer forming the emission surface of the underground space structure is a material layer having the transmission of electrical waves better than or equal to that of the wall surface of the underground space.

In a fifth aspect of the present invention, there is provided a buried radio device according to the above fourth aspect, wherein a layer forming the emission surface of the underground space structure comprises a waterproof layer.

The layer forming the emission surface of the underground space structure contains a material with a small loss of electric waves, e.g., a general pavement material, an asphalt layer, a crushed-stone layer having a surface covered with an asphalt pavement, a concrete, a brick or a concrete block. If needed, means for preventing the water seepage can be arranged at a portion of several to thirty centimeters from the surface.

In a sixth aspect of the present invention, there is provided a buried radio device according to the above first aspect, wherein a ring portion on the surface of the buried structure of the underground space structure comprises an asphalt layer, and the wall surface comprises concrete, and the outside of the wall surface is soil at the install place.

In a seventh aspect of the present invention, there is provided a buried radio device according to the above first aspect, wherein the underground antenna is an antenna having the structure for suppressing one-dimensional emission in the down direction.

In a eighth aspect of the present invention, there is provided a buried radio device according to the above seventh aspect, wherein the underground antenna is a λ/4 antenna having a reflecting plate on the bottom surface, and is set by selecting the position in the underground space.

In a ninth aspect of the present invention, there is provided a buried radio device according to any one of the above first to eighth aspects, wherein the diameter D is an effective diameter D corresponding to the length of short side of rectangle or short diameter of ellipse when the outer shape of the cover in the underground space has a shape other than the circle including rectangle.

In the buried radio device according to the above first aspect of the present invention, the communication from/on the ground is realized without changing the existing underground equipment.

In the buried radio device according to the above second aspect of the present invention, the angle of elevation of emitted electrical waves coming through the ground is determined depending on the rate D/λ and the position of underground antenna to the cover.

In the buried radio device according to the above third aspect of the present invention, the distribution of emitted electrical waves on the ground is prescribed by combined electrical waves of the electrical waves emitted from the equivalent wave-source.

In the buried radio device according to the above fourth aspect of the present invention, the layer forming the emission surface of the underground space structure is a material layer having the transmission characteristics of electrical waves which is better or at least equal to those of the walls and the surrounding soil.

In the buried radio device according to the above fifth aspect of the present invention, the waterproof layer is formed, thereby suppressing the loss of the emission surface.

The buried radio device according to the above sixth aspect of the present invention is applied to a general manhole.

In the buried radio device according to the above seventh aspect of the present invention, the primary emission in the down direction is suppressed by the introduction of the metal disk.

In the buried radio device according to the above eighth aspect of the present invention, the position of the λ/4 rod antenna having the reflecting plate on the bottom surface thereof is selected and is installed in the space under the ground, and a desired emission property is selected.

In the buried radio device according to the above ninth aspect of the present invention, the outer shape of the cover in the space under the ground has a shape other than circle, including rectangle.

### BRIEF DESCRIPTION OF THE DRAWINGS

FIG. 1A is a schematic diagram showing a typical water-supply manhole having a buried radio device according to the present invention;

FIG. 1B is an enlarged cross-sectional view showing a part of the iron cover and the receiving ring holding the cover;

FIG. 2 is a perspective view showing a coordinate system used for analyzing and testing the buried radio device according to the present invention;

FIG. 3 is a perspective view showing the calculation domain, in which the electromagnetic fields are evaluated by means of the three-dimensional numerical calculation according to a first embodiment;

FIG. 4 is an explanatory diagram of a snap shot of the distribution of electric-field (absolute) in the xz plane according to the first embodiment;

FIG. 5 is a graph showing an example of the directive property or the directivity of radio waves of the buried radio device in the xz plane according to the first embodiment of the present invention;

FIG. 6A is a graph showing the distribution of strength of electric field (absolute) of the buried radio device along a line of 1.5 m from the ground according to the first embodiment of the present invention;

FIG. 6B is a graph showing the distribution of strength of electric field (absolute) of the buried radio device along a line of 3.0 m from the ground according to the first embodiment of the present invention;

FIG. 7 is a graph showing the comparison between the actual measurement and the calculation of the distribution of electric field of the buried radio device according to the first embodiment of the present invention;

FIG. 8 is a graph showing an example of the directivity of radio waves of a buried radio device in the xz plane according to a second embodiment of the present invention;

FIG. 9 is a graph showing the distribution of strength of electric field (absolute) of the buried radio device along a line of 3.0 m from the ground according to the second embodiment of the present invention;

FIG. 10 is a graph showing an example of the directivity of radio waves of a buried radio device in the xz plane according to a third embodiment of the present invention;

FIG. 11 is a graph showing the distribution of strength of electric field (absolute) of the buried radio device along a line of 3.0 m from the ground according to the third embodiment of the present invention;

FIG. 12 is a graph showing an example of the directivity of radio waves of a buried radio device in the xz plane according to a fourth embodiment of the present invention;

FIG. 13 is a graph showing the distribution of strength of electric field (absolute) of the buried radio device along a line of 3.0 m from the ground according to the fourth embodiment of the present invention;

FIG. 14 is a graph showing the influence of changes in the dielectric properties of the soil, concrete, and asphalt (MMI, MMII, MMIII) on the distribution of strength of electric field at a frequency of 430 MHz according to the first embodiment of the present invention;

FIG. 15 is a graph showing the influence of changes in the dielectric properties of the soil, concrete, and asphalt (MMI, MMII, MMIII) on the distribution of strength of electric field at a frequency of 915 MHz according to the second embodiment of the present invention;

FIG. 16 is a graph showing the influence of changes in the dielectric properties of the soil, concrete, and asphalt (MMI, MMII, MMIII) on the distribution of strength of electric field at a frequency of 1,500 MHz according to the third embodiment of the present invention;

FIG. 17 is a graph showing the influence of changes in the dielectric properties of the soil, concrete, and asphalt (MMI, MMII, MMIII) on the distribution of strength of electric field at a frequency of 2,400 MHz according to the forth embodiment of the present invention;

### DESCRIPTION OF THE PREFERRED EMBODIMENTS

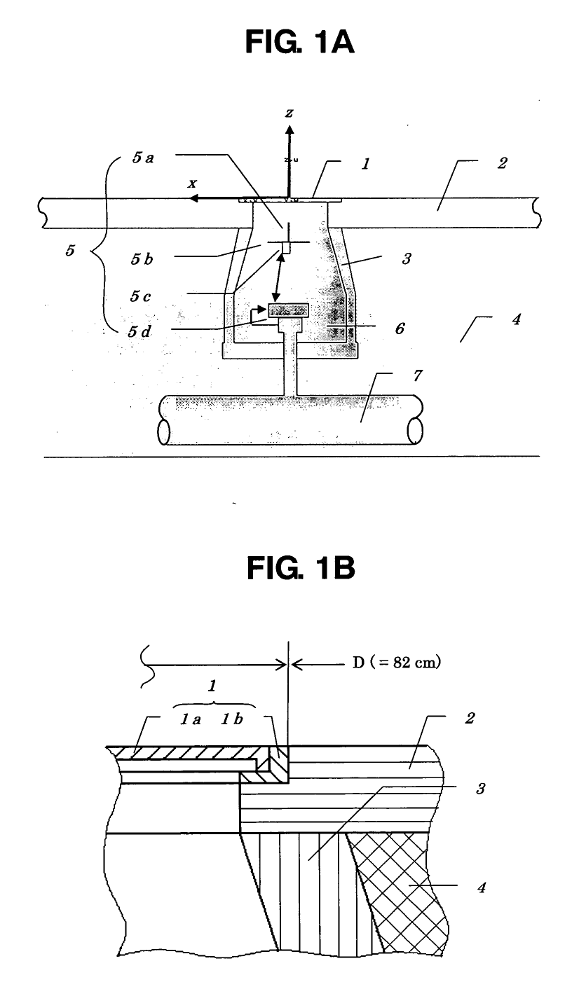

Embodiments of the present invention will be described below with reference to the accompanying drawings and others. FIG. 1A is a schematic cross-sectional view showing the install of a buried radio device to a typical water-supply manhole according to the present invention. FIG. 1B is a cross-sectional view showing partly enlarging the cross-sectional view shown in FIG. 1A.

Referring to FIGS. 1A and 1B, a water pipe 7 is buried under soil (soil layer) 4. A manhole of the water pipe 7 is installed. The manhole ensures inner space by a concrete wall 3, and comprises a manhole iron cover 1 thereon. An asphalt layer 2 has a receiving ring 1b which is buried under and is fixed to the asphalt layer 2. An iron cover main body 1a is detachably held by the receiving ring 1b. A water-pipe air valve 6 is projected from the bottom of the concrete wall 3 in the inner space. A sensor (not shown) arranged for pipe obtains data on the pressure or speed of distributed water or the like. The data is sent on the ground via an underground radio device, and information on a ground radio device (not shown) is sent to the underground radio device. The underground antenna of the underground radio device is arranged according to the first embodiment, which will be described later. Based on the above-mentioned typical example, the concept of the present invention will be described.

(Size of Manhole Iron Cover and Wavelength of Radio Waves)

Various sizes of the manhole iron cover (diameter or longitudinal length and lateral length) are equal to or excessively higher than those of wavelength of radio waves used for general radio connection in many cases. Therefore, the various sizes of the manhole iron cover become an obstacle against the emission of electrical waves to the space on the ground. Further, the soil, concrete, or asphalt around the manhole is used as an absorbing member of electrical waves. Thus, as mentioned above, the radio connection between the inside and the outside of the manhole uses the method for using the manhole iron cover as an antenna, the method for including the antenna to the manhole iron cover, and the method for transmitting electrical waves by making a hole to the manhole iron cover. However, any of the methods is not widely used. In the buried radio device according to the present invention, D/λ is introduced as an index indicating the size of manhole cover to a wavelength λ of electrical waves. Here, D denotes an effective diameter which is determined by an equation of D=2(S/π)^{1/2} conventionally using an area S of the cover. When D/λ<<1, the cover does not become an obstacle against the transmission of electrical waves. On the other hand, when D/λ>>1, the cover becomes an obstacle against the electrical waves. A value of D/λ ranges from 1 to 10 based on the combination of various dimensions of the manhole cover and of the used frequency of electrical waves.

(Emission of Electrical Waves Around the Manhole)

In many cases, the surface layer with the structure around the manhole is covered with asphalt or concrete. The rates of absorption of asphalt and concrete are lower than that of soil at the frequency range of several hundreds MHz to several GHz. Therefore, the radio connection between the inside and the outside of the manhole is established by using electrical waves which transmit through a pavement layer of asphalt or concrete over the ground.

If the asphalt or concrete pavement is not employed, electrical waves come through the ground from the soil layer near the ground surface. In this case, the electrical waves emitted to the ground space vary depending on the percentage of moisture content of soil, and are weaker in many cases, as compared with that in the asphalt or concrete pavement. According to the present invention, an electric device arranged in the buried structuring member is connected by radio to an electronic device on the ground by actively using the electrical waves coming through the ground.

According to the present invention, the technology of radio connection between the inside and the outside of manhole is provided under given conditions, that is, the size of manhole, the environment of electrical waves at the install position of manhole, and the frequency of electrical waves used for radio connection. The technology comprises the following elements for radio connection.

1. Selection of the position of the antenna for effective emission of the power outputted from the radio device in the manhole to the upper space

2. Antenna structure for effective emission of the power outputted from the radio device in the manhole to the upper space

3. Selection of the position of the radio device in the upper space to ensure a stable link

The realization of the technology elements uses, as a powerful tool, the prediction of the property of radio emission using the analysis of three-dimensional electromagnetic field or the numerical simulation. Because there are various objects near the radio antenna, such as a manhole iron cover, a concrete wall, an asphalt layer and a water pipe, which scatter and absorb the radio waves, the distribution of radio waves tends to become quite complicated. For this reason, the property of radio emission can be predicted with high accuracy only by analyzing the three-dimensional electromagnetic field. The property of radio emission to the space on the ground depends on the following elements.

1. Structure of underground buried structuring member, such as a manhole

2. Structure of antenna

3. Relative position and direction of antenna (to the structure of manhole)

4. Frequency of used electrical waves

5. Dielectric property of soil, concrete and asphalt

With the structure of manhole and the dielectric properties of soil, concrete and asphalt are considered given, a model is constructed, and the three-dimensional numerical analysis of electromagnetic field (numerical simulation) is executed.

FIG. 1A is a cross-sectional view showing the model of a typical water-supply manhole. The diameter of iron cover of the manhole is 82 cm. The thickness of asphalt layer is 24 cm, including a lower crushed-stone layer. Although the actual shape of concrete wall is not axially symmetric, exactly speaking, it is approximated as axially symmetric in the model. An antenna installed in the manhole is a λ/4 (λ: wavelength) rod antenna with a reflecting plate, and is arranged on the central axis of the iron cover of the manhole. The reflecting plate is so arranged that it increases the power emitted to the upper space on one hand and, on the other hand, it suppresses the primary radio emission in the down direction to result in suppression of power absorbed by the soil.

(Dielectric Property)

As mentioned above, in order to analyze the property of radio emission, the dielectric properties of the soil, concrete and asphalt must be known. Here, based on values described in the following documents [1] to [3], a value at the used frequency is estimated, and three models are compiled and are used in the numerical analysis.

Documents:

[1] A. von Hippel Ed., “Dielectric Materials and Applications,” Artech House, 1995; Originally published by Technology Press of MIT, 1954, pp. 314, 356

[2] ITU-R P. 527-3, “Electrical Characteristics of The Surface of the Earth”

[3] ITU-R P. 1238-3, “Propagation Data and Prediction Methods for the Planning of Indoor Radiocommunication Systems and Radio Local Area Networks in the Frequency Range 900 MHz to 100 GHz”

Values given in the documents [1] to [3] indicate a general trend such that the dielectric loss is larger for the soil and concrete than for the asphalt in a frequency range from 300 MHz to 3 GHz. The dielectric loss of asphalt is low and, in the case of the asphalt having the thickness of 10 to 30 cm, the electromagnetic waves are transmitted with practical strength.

The frequency of electrical waves relevant to the present invention ranges from several hundreds MHz to several GHz. Of the frequencies in this range, 868 MHz, 915 MHz, 1500 MHz, and 2400 MHz are considered here in the present discussion. These particular frequencies are either legally permitted or would be permitted in the future to use for a kind of radio applications relevant to the present invention. Hereinafter, the three Material Models, namely, MMI, MMII, and MMIII are shown, as Tables 1 to 3, with varied dielectric properties.

TABLE 1
Material Model I

| Material | | Frequency (MHz) | | | | | |
|---|---|---|---|---|---|---|---|
| (Moisture %) | Diel. Const | 430 | 868 | 915 | 1500 | 1900 | 2400 |
| Loamy soil | ε′/ε₀ | 20 | 20 | 20 | 20 | 20 | 20 |
| 13.7% | tanδ | 0.16 | 0.15 | 0.15 | 0.14 | 0.14 | 0.13 |
| Concrete | ε′/ε₀ | 7.0 | 7.0 | 7.0 | 7.0 | 7.0 | 7.0 |
| | tanδ | 0.12 | 0.12 | 0.12 | 0.12 | 0.12 | 0.12 |
| Cenco Sealstix* | ε′/ε₀ | 3.15 | 3.12 | 3.11 | 3.07 | 3.04 | 3.00 |
| | tanδ | 0.026 | 0.025 | 0.025 | 0.024 | 0.023 | 0.022 |

*Asphalt

TABLE 2
Material Model II

| Material | | Frequency (MHz) | | | | | |
|---|---|---|---|---|---|---|---|
| (Moisture %) | Diel. Const | 430 | 868 | 915 | 1500 | 1900 | 2400 |
| Clay soil | ε′/ε₀ | 19.6 | 18.2 | 18.0 | 16.1 | 14.8 | 13.2 |
| 20.09% | tanδ | 0.51 | 0.46 | 0.46 | 0.40 | 0.36 | 0.31 |
| Concrete | ε′/ε₀ | 7.0 | 7.0 | 7.0 | 7.0 | 7.0 | 7.0 |
| | tanδ | 0.12 | 0.12 | 0.12 | 0.12 | 0.12 | 0.12 |
| Cenco Sealstix* | ε′/ε₀ | 3.15 | 3.12 | 3.11 | 3.07 | 3.04 | 3.00 |
| | tanδ | 0.026 | 0.025 | 0.025 | 0.024 | 0.023 | 0.022 |

*Asphalt

TABLE 3
Material Model III

| Material | | Frequency (MHz) | | | | | |
|---|---|---|---|---|---|---|---|
| (Moisture %) | Diel. Const | 430 | 868 | 915 | 1500 | 1900 | 2400 |
| Loamy soil 13.7% | ε′/ε₀ | 20 | 20 | 20 | 20 | 20 | 20 |
| | tanδ | 0.16 | 0.15 | 0.15 | 0.14 | 0.14 | 0.13 |
| Concrete | ε′/ε₀ | 7.0 | 7.0 | 7.0 | 7.0 | 7.0 | 7.0 |
| | tanδ | 0.12 | 0.12 | 0.12 | 0.12 | 0.12 | 0.12 |
| Millimar* | ε′/ε₀ | 2.62 | 2.60 | 2.60 | 2.57 | 2.55 | 2.53 |
| | tanδ | 0.0011 | 0.0011 | 0.0011 | 0.0011 | 0.0011 | 0.0011 |

*Asphalt

### First Embodiment

In the buried radio device according to the first embodiment of the present invention, as shown in FIG. 1A, the underground radio device 5 comprises the λ/4 rod antenna 5a, the metallic reflecting plate 5b, a radio-device case 5c and a processing device 5d. The processing device 5d has a function for processing a signal from the above-mentioned sensor or sending a control signal to another circuit, and is connected to a high-frequency receiving and sending circuit included in the radio-device case 5c. As described later, the position of the λ/4 rod antenna 5a in the space can be adjusted in accordance with a purpose, and is arranged vertically to the center of the concrete wall 3 in the z-direction according to the first embodiment.

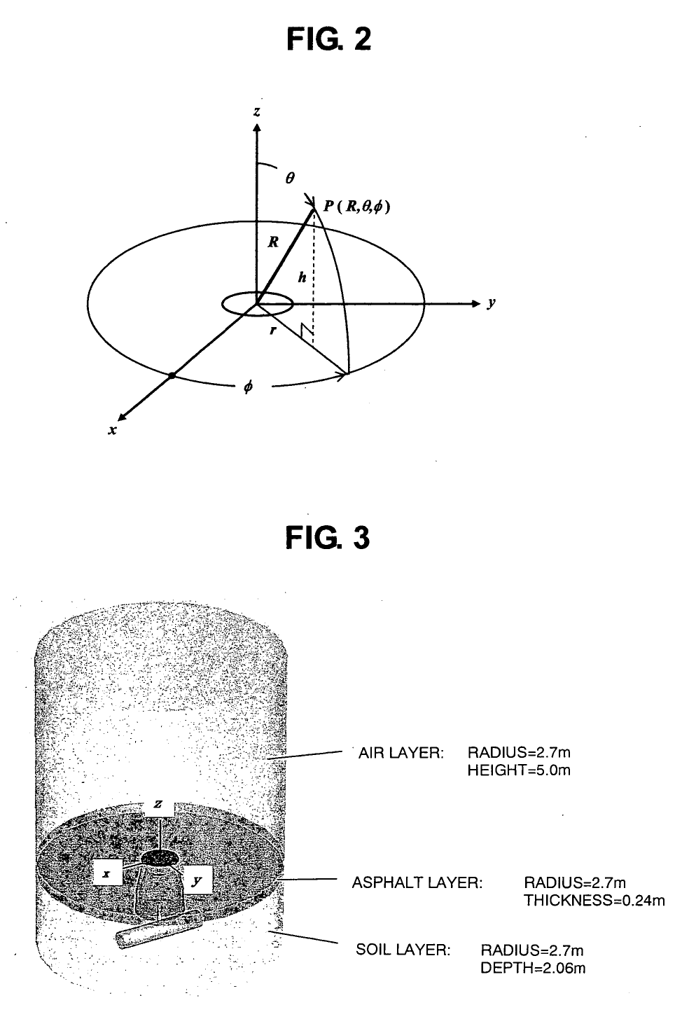

To the model of water-supply manhole, the analysis of three-dimensional electromagnetic field is executed at a frequency of 430 MHz. FIG. 2 shows a coordinate system used for analysis. The center point of the surface of manhole iron cover is the origin of coordinates. The coordinate system is similarly used according to another embodiment. Referring to FIG. 2, the origin of coordinates is the center point of the surface of manhole iron cover, and the diameter of cover is 82 cm. A point P represents an observation point of the electromagnetic field. The structure of manhole, the used frequency, and the dielectric properties of soil, concrete and asphalt are given. Thereafter, the analysis of three-dimensional electromagnetic field is executed and the emission property of electromagnetic field to the upper space is predicted. At the position having a predicted value of the strength of emitted electric field which is over a predetermined value, an antenna for outer radio-device is installed and the radio connection between the inside and the outside of manhole is established.

(Data According to the First Embodiment)

Manhole (cover): typical water-supply manhole

Diameter of manhole cover: 82 cm

Frequency: 430 MHz (wavelength in free space: λ=69.8 cm)

Size index of cover: D/λ=1.17

Dielectric property: MMI
Soil (weight percentage of moisture: 13.7%): ε/ε₀=20,
   tan ε=0.16
Concrete: ε/ε₀=7.0, tan ε=0.12
Asphalt: ε/ε₀=3.15, tan ε=0.026

Antenna position: on central axis of manhole

The three-dimensional analysis of electromagnetic field according to the first embodiment uses the following calculating domain shown in FIG. 3.

Air layer on the ground: radius 2.7 m, height 5.0 m

Asphalt layer: radius 2.7 m, thickness 0.24 m

Soil layer under the down surface of asphalt pavement: radius 2.7 m,
depth 2.06 m
   The calculation domain is split up into a large number (approximately, 6×10⁶) of small cuboids, so-called grid cells. With the aid of the grid cells, the spatial discretization of Maxwell's equations is performed, and the numerical calculation is executed on a PC to obtain the distribution of electromagnetic field in the calculation domain.

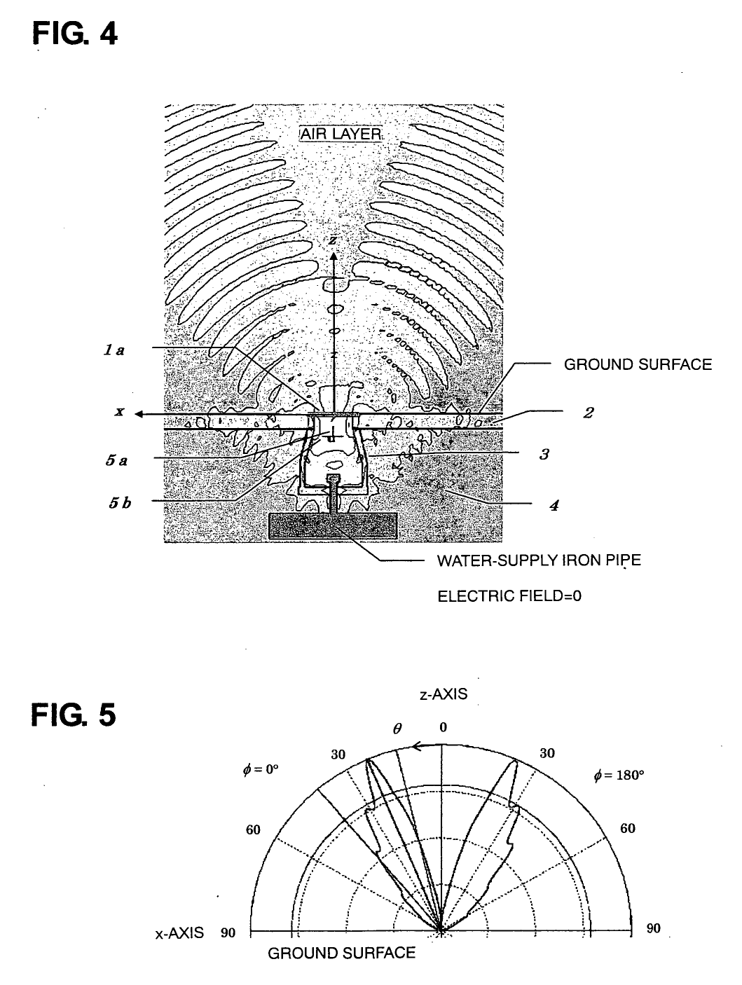

FIG. 4 shows a snap shot of the distribution of electric field (absolute) in the xz plane obtained by the numerical calculation. A portion close to the white on a monochrome screen corresponds to a portion with strong strength of electric field. The frequency is 430 MHz, and the model dielectric property is MMI.

Referring to FIG. 4, a result of numerical calculation preferably shows the following situations.

(1) The electrical waves emitted from the antenna are reflected by a wall surface and the manhole cover to form a complicated distribution of electromagnetic field. The field is stronger inside the manhole than outside.

(2) A part of the emitted electrical waves is transmitted through the concrete wall and absorbed by the soil layer.

(3) A part of the emitted electrical waves is propagated in the asphalt layer in the radial direction over a distance of a few wavelengths.

(4) A part of the electrical waves propagated in the asphalt layer in the radial direction emerges from the surface into the space on the ground.

(5) As a result, the doughnut-shaped asphalt layer ring around the iron cover serves as a distributed wave-source of the electromagnetic field in the space above the ground.

FIG. 3 is a perspective view showing the calculation domain, in which the electromagnetic fields are evaluated by means of the three-dimensional numerical calculation according to a first embodiment. The radius of air layer is 2.7 m, and the height is 5 m. The radius of asphalt layer is 2.7 m, and the thickness is 0.24 m. The radius of soil layer is 2.7 m, and the depth is 2.06 m.

Direct application of the three-dimensional numerical calculation to the analysis of electromagnetic field in the space wider than the calculation domain shown in FIG. 3 is not possible because of the limitation on the memory capacity of the PC. Therefore, an electromagnetic field in a far field is calculated by introducing the approximation widely used for far-field solution. FIG. 5 shows an emission or radiation pattern in the xz plane obtained by the far-field approximation. The figure shows the dependence of the strength of electric field (absolute) on the angle θ in the xz plane, i.e. in the plane of φ=0° and φ=180°. The strength of the field is given in a linear scale. The directional angle of the main lobe is 23.0° and the half beam width (3 dB) is 26.5°. The frequency is 430 MHz, and the model dielectric property is MMI. The pattern in three-dimensional space is inverted conical-shaped, being a figure of revolution of the pattern shown in FIG. 5 around the z axis. Only one robe is formed in this case, as shown in FIG. 5. The reason for the formation of single robe radiation pattern is that the effective diameter of the distributed wave-source around the iron cover (diameter D: 82 cm) is close to the wavelength (wavelength λ in free space: 69.8 cm), i.e. D/λ=1.17.

Results of the numerical calculation indicate that a large portion of the emission energy is absorbed by the concrete wall and the soil layer. In order to suppress the absorption and increase the energy radiated into the space above the ground, a metallic reflecting plate is introduced, as shown in FIGS. 1 and 4. Larger plate is more effective for this purpose, on one hand. But, on the other hand, smaller plate is more desirable for ease in practical installment. The diameter of the reflecting disk is chosen at around λ/4 as a practical compromise of these requirements. With this choice under other conditions of embodiment 1, about 16% of the emitted energy is radiated into the space above the ground according to the numerical calculation.

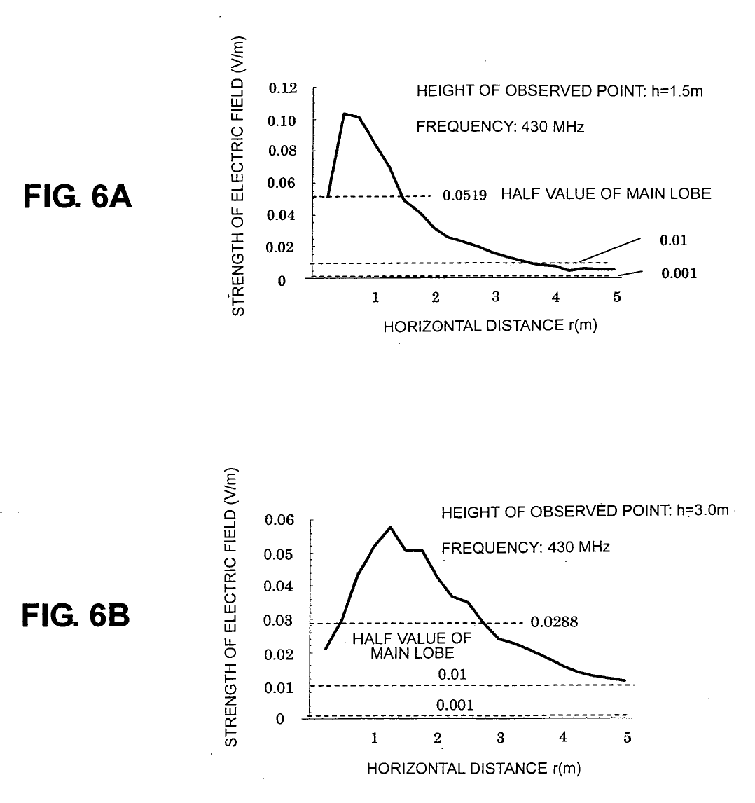

From the directivity pattern, as shown in FIG. 5, the strength of electric field at the point of observation in space is obtained. FIGS. 6A and 6B show the distributions of electric field strength (absolute) along lines at heights, h=1.5 m, and h=3.0 m, respectively, from the ground. In the calculation, an output power of transmitter is set at 10 mW. Referring to FIGS. 6A and 6B, the symbol r denotes the horizontal distance from the center of manhole cover. When the field strength at a position of the receiving antenna above the ground exceeds a certain level, a stable radio connection is established between the radio devices inside and outside of manhole. A minimum field strength needed for stable radio connection may be inferred from operating characteristics of a typical field-strength meter comprising a high-sensitivity receiver (minimum input voltage: 1 μV), a 10m-coaxial cable and a standard dipole antenna. Field strength of about 35 μV/m at the dipole antenna site produces a voltage of 1 μV at the input port of receiver. With an ample margin added on top of 35 μV/m, 1 mV/m is chosen here for the purpose of clarification as the limiting level of field strength for practical radio connection in the present discussion.

Referring back to FIGS. 6A and 6B, horizontal lines at 1 mV/m, 10 mV/m, and a half value of the peak of main lobe (51.9 mV/m in FIG. 6A, 28.8 mV/m in FIG. 6B) are entered in the figures. The ranges of r corresponding to the field strengths exceeding these levels are referred to as the stable, recommended, and marginal ranges for radio connection, respectively;

Stable range: 0.25<r<1.5 m at h=1.5 m
0.5<r<2.8 m at h=3.0 m

Recommended range: 0.25<r<3.7 m at h=1.5 m
0.25<r<5.0 m at h=3.0 m

Marginal range: 0.25<r<5.0 m at h=1.5 m
0.25<r<5.0 m at h=3.0 m

In summary, the antenna above ground can be arranged at almost any point in the region of circular cylinder defined by a radius of 5 m and a height of 3 m, except for a narrow region around the vertical axis (r<2.5 m), to establish a radio connection between the wireless devices placed inside and outside of the manhole. Furthermore, the stable radio connection is ensured by arranging the outside antenna in the region of main lobe of radiation from the inside device.

(Verification of Numerical Calculation Results with the Experimental Test)

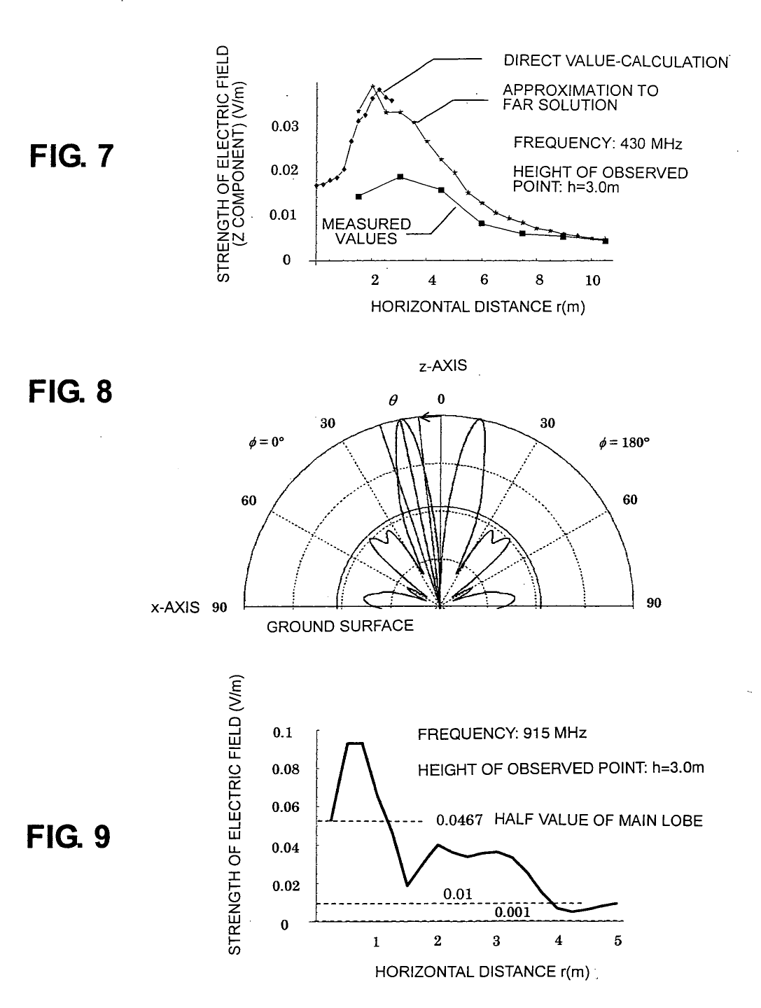

An experiment is made to test the numerical simulation. In the experiment, the vertical component (z component) of the emitted electrical wave is measured. An example of measurement results is presented by the heavy boxes in FIG. 7. FIG. 7 is a graph showing the comparison between the results of actual measurement (boxes) and numerical calculation (direct calculation: diamonds, far-field approximation: stars) of the distribution of electric field emitted by the buried radio device according to the first embodiment of the present invention. The measurement uses an instrument with sensitivity of 1 μV, i.e. the minimum voltage at the input port of receiver is 1 μV. Values predicted by the numerical calculation are fairly close to those obtained by the measurement and shapes of the curves are similar, although former are slightly larger than the latter. It is concluded that the validity of the numerical simulation is supported by the experimental measurement.

(Feasibility of Radio Connection at Other Frequencies)

Using the three-dimensional numerical simulation, a feasibility study of radio connection at frequencies, 815 MHz, 915 MHz, 1500 MHz, 1900 MHz, and 2400 MHz has been made. Results of radiation pattern and the distribution of strength of electrical field along a line at a height, h=3.0 m, obtained at 915 MHz, 1500 MHz and 2400 MHz are presented in the followings.

### Second Embodiment

The second embodiment of the present invention will be described below.

(Data according to the second embodiment)

Manhole: typical water-supply manhole (FIG. 1)

Diameter of manhole cover: 82 cm

Frequency: 915 MHz (Wavelength in free space: μ=32.79 cm)

Size index of cover: D/λ=2.50

Dielectric property: MMI
Soil (weight percentage of moisture: 13.7%): ε/ε₀=20,
   tan δ=0.15
Concrete: ε/ε₀=7.0, tans δ=0.12

Asphalt: ε/ε₀=3.11, tan δ=0.025

Antenna position: on central axis of manhole

FIG. 8 is a graph showing an example of directivity in the xz plane (i.e. φ=0° and φ=180° plane) of the radiation from the buried radio device operating at 915 MHz. The directional angle of main lobe is 12°, and the half-width of main lobe is 11.5°. In addition to the main lobe, two side lobes exist in this case.

FIG. 9 shows the distribution of electric field (absolute) of the buried radio device along a line at h=3.0 m from the ground. The output power of transmitter is set at 10 mW in the calculation. From FIG. 9, the following statement can be made:

Stable connection range of r ((Field strength)>46.7 mV/m):

0.25<r<1.2 m at h=3.0 m

Recommended range of r ((Field strength)>10 mV/m):

0.25<r<3.9 m at h=3.0 m

Marginal range of r ((Field strength)>1 mV/m):

0.25<r<5.0 m at h=3.0 m

In spite of a dip in the distribution of field strength at around r=1.5 m, the minimum value is at 19 mV/m, which is strong enough to hold the radio connection.

According to the second embodiment, the size index D/A of the cover is 2.50, which is much larger than 1. A distributed wave-source with large D/λtends to form side lobes, to make the half-width narrow (11.5°), and to shoot up the main lobe high (θ=12°). Consequently, the strength of electric field tends to change greatly as the position of the observation point changes slightly. This is not preferable for practical implementation of the wireless connection technique. In order to improve the above-mentioned point, a new technique is proposed in the present invention, in which an antenna is installed near the periphery of the manhole cover. Advantages brought about by this new technique will be described below in connection with the third and fourth embodiments.

### Third Embodiment

The third embodiment obtained by modifying the second embodiment will be described below.

(Data According to the Third Embodiment)

Manhole: typical water-supply manhole (FIG. 1)

Diameter of manhole cover: 82 cm

Frequency: 1500 MHz (wavelength in free space: λ=20.0 cm)

Size index of cover: D/λ=4.1

Dielectric property: MMI
Soil (weight percentage of moisture: 13.7%): ε/ε₀=20,
   tan δ=0.14
Concrete: ε/ε₀=7.0, tan δ=0.12
Asphalt: ε/ε₀=3.07, tan δ=0.024

Antenna position: on the vertical line at (x=−18.8 cm, y=0),
the distance between the center line of antenna and
the periphery of manhole cover =22.1 cm

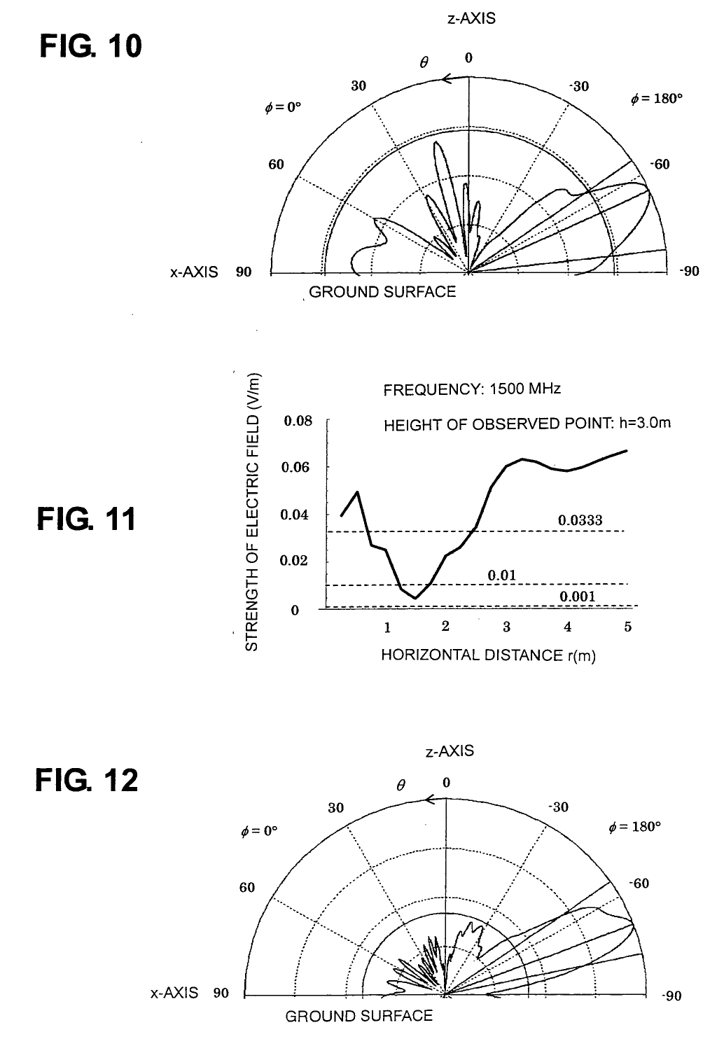

FIG. 10 is a graph showing an example of the directivity pattern of radiation from a buried radio device. FIG. 10 shows the directivity pattern in the xz plane (in the φ=0° and φ=180° plane) at a frequency of 1500 MHz. Since the axis of antenna is at the position of 18.8 cm in the negative direction on the x-axis, the radiation pattern is not symmetric about the x=0 plane, and the strength of emitted electromagnetic field is stronger in the region of negative x-axis than in the region of positive x-axis. The directional angle of main lobe is θ=−65° in the φ=180° plane. The half-width of main lobe is 28.2° in this plane, which may be considered wide. Side lobes are formed in the φ=0° plane, i.e. in the region of positive x, but it is advantageous and is recommended to use the main lobe for radio connection.

FIG. 11 shows the distribution of electric field (absolute) of the buried radio device along a line at h=3.0 m from the ground. The output power of transmitter is set at 10 mW in the calculation. From FIG. 11, the following statement can be made:

Stable connection range of r ((Field strength)>33.3 mV/m):

2.5<r<5.0 m at h=3.0 m

Recommended range of r ((Field strength)>10 mV/m):

0.25<r<1.2 m and 1.8<r<5.0 m at h=3.0 m

Marginal range of r ((Field strength)>1 mV/m):

0.25<r<5.0 m at h=3.0 m

In spite of a dip in the distribution of field strength at around r=1.5 m, the minimum value is at 19 mV/m, which is strong enough to hold the radio connection.

According to the third embodiment, the size index D/λ of the cover is 4.1, which is much larger than 1. A distributed wave-source with a large, D/λ=4.1, forms a number of side lobes in addition to the main lobe, as discussed previously with regard to the second embodiment. This unfavorable radiation property is overcome by installing the antenna near the periphery of the manhole cover. Advantages brought about by this new technique are a wide half-width combined with a low elevation angle of the main lobe, resulting in a wide range of r for stable radio connection.

### Fourth Embodiment

The fourth embodiment of the present invention will be described below.

(Data According to the Fourth Embodiment)

Manhole: typical water-supply manhole (FIG. 1)

Diameter of manhole cover: 82 cm

Frequency: 2400 MHz (wavelength in free space: λ=12.5 cm)

Size index of cover: D/λ=6.56

Dielectric property: MMI
Soil (weight percentage of moisture: 13.7%): ε/ε₀=20,
   tan δ=0.13
Concrete: ε/ε₀=7.0, tan δ=0.12
Asphalt: ε/ε₀=3.07, tan δ=0.022

Antenna position: on the vertical line at (x=−22.0 cm, y=0),
the distance between the center line of antenna and
the periphery of manhole cover =19.0 cm

FIG. 12 is a graph showing an example of the directivity pattern of radiation from a buried radio device. FIG. 12 shows the directivity pattern in the xz plane (in the φ=0° and φ=180° plane) at a frequency of 2400 MHz. Since the axis of antenna is at the position of 18.8 cm in the negative direction on the x-axis, the radiation pattern is not symmetric about the x=0 plane, and the strength of emitted electromagnetic field is stronger in the region of negative x-axis than in the region of positive x-axis. The directional angle of main lobe is θ=−69.0° in the φ=180° plane. The half-width of main lobe is 22.9° in this plane, which may be considered wide. Although weak side lobes are formed in the φ=0° plane, i.e. in the region of positive x, it is advantageous and is recommended to use the main lobe for radio connection.

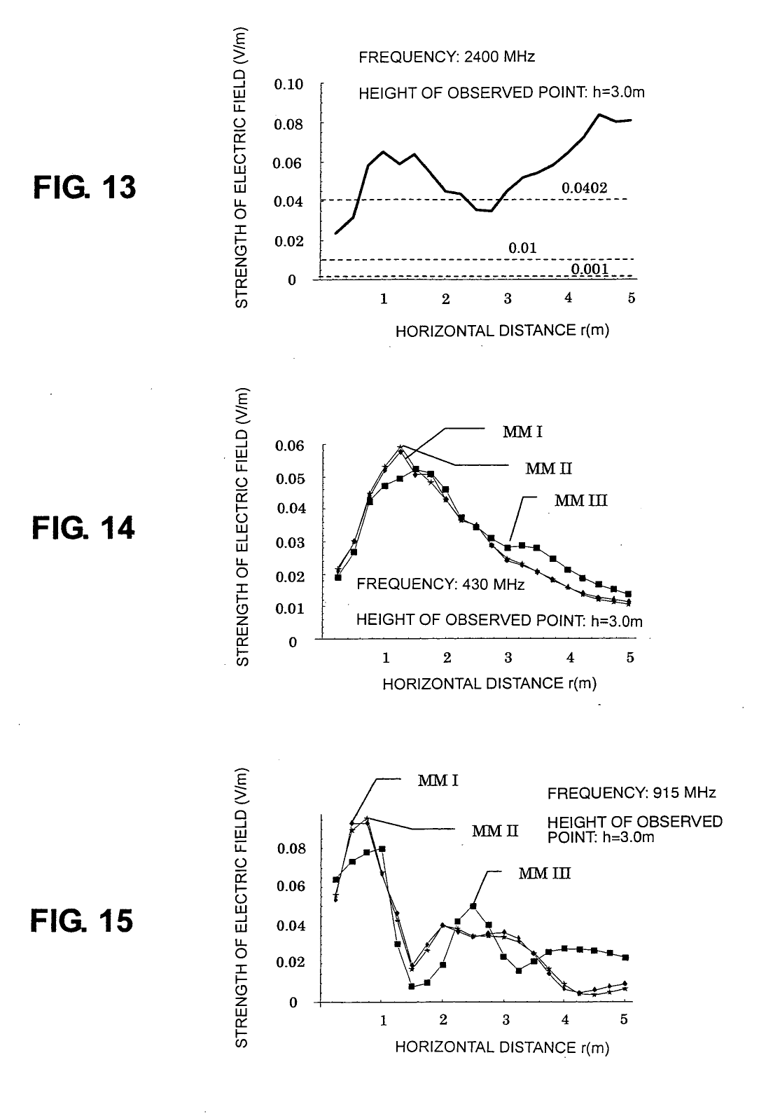

FIG. 13 shows the distribution of electric field (absolute) of the buried radio device along a line at h=3.0 m from the ground. The output power of transmitter is set at 10 mW in the calculation. From FIG. 13, the following statement can be made:

Stable connection range of r ((Field strength)>40.2 mV/m):

0.6<r<2.2 m and 2.9<r<5.0 m at h=3.0 m

Recommended range of r ((Field strength)>10 mV/m):

0.25<r<5.0 m at h=3.0 m

Marginal range of r ((Field strength)>1 mV/m):

0.25<r<5.0 m at h=3.0 m

In spite of a minor dip in the distribution of field strength at around r=2.5 m, the minimum value is at about 30 mV/m, which is strong enough to hold the radio connection.

According to the fourth embodiment, the size index D/λ, of the cover is 6.56, which is much larger than 1, thus the antenna is arranged near the periphery of the manhole cover. This arrangement successfully produced a low-elevation-angle (21°) main lobe with a wide half-width (22.9°) to result in a fairly smooth and strong distribution of electric field exceeding 10 mV/m over a wide range of horizontal distance r, as shown in FIG. 13.

The results of numerical simulation according to the third and fourth embodiments demonstrate that it is advantageous to arrange an antenna near the periphery of the manhole cover, when the manhole cover is large compared with the wavelength, that is, when the size index D/λ is much larger than 1. Furthermore, the new technology according to the present invention extends the range of frequencies applicable to the wireless connection between buried and above-ground radio devices at least up to 2400 MHz.

(Influence of Changes in Dielectric Properties of the Soil, Concrete and Asphalt ON the Distribution of Electric Field)

Next, the influence of changes in dielectric properties of the soil, concrete and asphalt according to the first through fourth embodiments will be described below. Assuming that the dielectric properties of the soil, concrete and asphalt are given by the three models, MMI, MMII and MMIII, the distribution of strength of electric field along a line at h=3.0 m is calculated. Results of the calculation are presented in FIGS. 14 through 17.

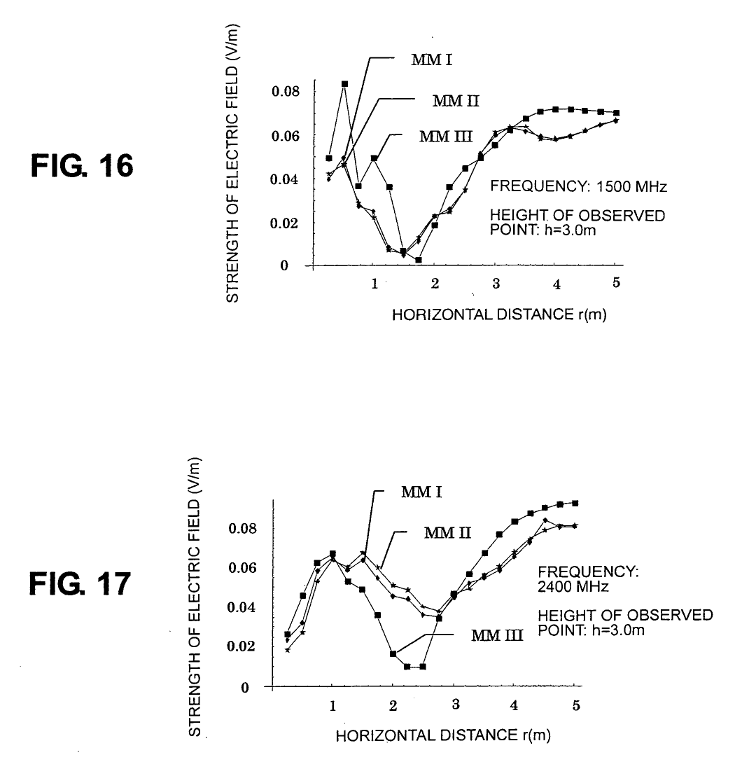

FIG. 14 is a graph showing the influence of changes in the dielectric properties on the distribution of strength of electric field according to the first embodiment, i.e. frequency of operation is at 430 MHz. FIG. 15 is a graph showing the influence of changes in the dielectric properties on the distribution of strength of electric field according to the second embodiment, i.e. frequency of operation is at 915 MHz. FIG. 16 is a graph showing the influence of changes in the dielectric properties on the distribution of strength of electric field according to the third embodiment, i.e. frequency of operation is at 1500 MHz. FIG. 17 is a graph showing the influence of changes in the dielectric properties on the distribution of strength of electric field according to the fourth embodiment, i.e. frequency of operation is at 430 MHz.

From the results presented in FIGS. 14 through 17 in connection with the dielectric properties given in Tables 1 to 3, the following conclusions can be drawn.

(1) From the figures, the electric field distributions for the models MMI and MMII along h=3.0 m line are nearly identical. It is attributed to that they employ the same asphalt, although they employ different types of soil, as seen from the tables.

(2) From the figures, the electric field distributions for the models MMIII along h=3.0 m line have different shapes from those for the models MMI and MMII. The electric field emitted to the space above the ground is stronger and its variation is larger for the model MMIII than for other two models. It is attributed to that the type of asphalt used in MMIII has a lower relative dielectric constant and a lower dielectric loss (a lower tan δ) than the asphalt used in other two models, as seen from the tables.

(3) The influence of the changes in the dielectric properties over a frequency range from 430 MHz to 2400 MHz on the strength of electric field emitted to the space above ground is found relatively small.

(4) According to the first through fourth embodiments, the strength of electric field emitted by a buried radio device exceeds the limit for the marginal reception, 1 mV/m, over a range of 0.25<r<5.0 m along a line at h=3.0 m.

The embodiments described in details can be modified further within the scope of the present invention. When the cover is not circular, the proper use of effective diameter enables the estimation of the emitted electric field based on the principles developed in the present invention. Furthermore, transmission of information from a radio device above the ground to a buried radio device can be realized by the technique developed in the present invention, and this is within the scope of the present invention.

The communication system from underground to above-ground and vice versa can be realized without modifying existing underground structure, such as manholes for various purposes, by using the technique developed for the buried radio device according to the present invention.

What is claimed is:

1. A buried radio device comprising:
an underground space structure comprising an underground space, a metallic cover on the underground space, and an emission surface having a ring area comprising a structure material with transmission of electrical waves surrounding the cover;
an underground radio device comprising an underground antenna arranged apart from the cover in the underground and a radio device connected to the antenna; and
a radio device on the ground comprising an antenna on the ground and the radio device connected to the antenna,
wherein the underground antenna and the antenna on the ground are connected via the emission surface having the ring area.

2. A buried radio device according to claim 1, wherein a diameter of the cover is D and a wavelength of carrier of the radio device is λ, a rate (D/λ) of the diameter D to the used wavelength λ is approximately equal or more, and the angle of elevation of emitted electrical waves coming through the ground is determined depending on the rate and the position of the underground antenna to the cover.

3. A buried radio device according to claim 2, wherein the electrical waves coming through the ground form a distribution of equivalent wave-source spreading over the emission surface having the surface of ring area comprising the structure material surrounding the cover, and the distribution of emitted electrical waves on the ground is prescribed by combined electrical waves emitted from the distributed equivalent wave-source.

4. A buried radio device according to claim 1, wherein a layer forming the emission surface of the underground space structure is a material layer having the transmission of electrical waves better than or equal to that of the wall surface of the underground space.

5. A buried radio device according to claim 4, wherein a layer forming the emission surface of the underground space structure comprises a waterproof layer.

6. A buried radio device according to claim 1, wherein a ring portion on the surface of the buried structure of the underground space structure comprises an asphalt layer, and the wall surface comprises concrete, and the outside of the wall surface is soil at the install place.

7. A buried radio device according to claim 1, wherein the underground antenna is an antenna having the structure for suppressing one-dimensional emission in the down direction.

8. A buried radio device according to claim 7, wherein the underground antenna is a λ/4 antenna having a reflecting plate on the bottom surface, and is set by selecting the position in the underground space.

9. A buried radio device according to any one of claims 1 to 8, wherein the diameter D is an effective diameter D corresponding to the length of short side of rectangle or short diameter of ellipse when the outer shape of the cover in the underground space has a shape other than the circle including rectangle.
